(19) United States
(12) Patent Application Publication
(10) Pub. No.: US 2025/0350054 A1
(43) Pub. Date: Nov. 13, 2025

(54) CIRCUIT BOARD ELECTRICAL CONNECTOR AND ELECTRICAL CONNECTOR ASSEMBLY

(71) Applicant: HIROSE ELECTRIC CO., LTD., Kanagawa (JP)

(72) Inventor: Hironobu ANDO, Kanagawa (JP)

(21) Appl. No.: 19/197,308

(22) Filed: May 2, 2025

(30) Foreign Application Priority Data
May 9, 2024 (JP) 2024-076392

(51) Int. Cl. H01R 12/73

(52) U.S. Cl. CPC H01R 12/737

(57) ABSTRACT

Provided is a circuit board electrical connector including: terminals; a fixed housing; and a moving housing, the moving housing includes: a pair of moving-side side walls; a receiving portion capable of receiving a counterpart connector, and a pair of restricted portions, the fixed housing includes a pair of fixed-side side walls located outward of the pair of moving-side side walls, end portions of the pair of fixed-side side walls extend further toward a mating side than end portions of the pair of moving-side side walls, each of the terminals includes a connecting portion, a contact portion, and an elastic portion, the contact portions are placed in such a manner as to face the receiving portion on opposing surface sides of the pair of moving-side side walls, and each of the elastic portions is provided to either of the pair of restricted portions on a side opposite to the mating side.

### CROSS-REFERENCE TO RELATED APPLICATION

This application claims priority from Japanese Patent Application No. 2024-076392 filed with the Japan Patent Office on May 9, 2024, the entire content of which is hereby incorporated by reference.

### BACKGROUND

### 1. Technical Field

The present disclosure relates to a circuit board electrical connector and an electrical connector assembly.

### 2. Related Art

Japanese Patent No. 7109303 discloses a connector assembly including a connector (first connector) that is mounted on a circuit board (first circuit board) and a counterpart connector (second connector) that is mounted on the other circuit board (second circuit board) and mated and connected to the connector (first connector) from above. The connector (first connector) includes a fixed housing, a moving housing, and a plurality of terminals (first contacts) that are arranged, extending from the fixed housing to the moving housing. Each of the terminals (first contacts) is created by bending a metal strip in its thickness direction, and a middle portion of each of the terminals is provided with an elastic portion that can be elastically displaced. The elastic portions are located in an internal space formed between a pair of side walls of the fixed housing. The elastic displacement of the elastic portions allows the moving housing to move relative to the fixed housing.

The moving housing includes a mating portion that can receive the counterpart connector (second connector) from above. The mating portion is located above the fixed housing in a connector mating direction (up-and-down direction) and is located inward of the pair of side walls of the fixed housing in a connector width direction (a direction perpendicular to both of a terminal arrangement direction and the connector mating direction). Therefore, gaps are formed between a lower end of the mating portion and upper ends of the side walls. Moreover, upper parts of the elastic portions of the terminals placed in the internal space of the fixed housing are located, facing the above gaps (refer to, for example, FIG. 14 of Japanese Patent No. 7109303).

### SUMMARY

A circuit board electrical connector according to an embodiment of the present disclosure is a circuit board electrical connector that is placed on a circuit board and is mated and connected to a counterpart connector, the circuit board electrical connector including: a plurality of terminals; a fixed housing configured to be fixed to the circuit board via the plurality of terminals; and a moving housing configured to be movable relative to the fixed housing. The circuit board electrical connector is configured such that, in the circuit board electrical connector, the plurality of terminals is arranged in a terminal arrangement direction perpendicular to a mating direction of the circuit board electrical connector and the counterpart connector and a width direction of the circuit board electrical connector, and is provided, extending from the fixed housing to the moving housing, the moving housing includes: a pair of moving-side side walls facing each other in the width direction; a receiving portion capable of receiving a part of the counterpart connector, the receiving portion being formed between the pair of moving-side side walls; and a pair of restricted portions capable of coming into contact with the fixed housing, the pair of restricted portions protruding outward of the pair of moving-side side walls in the width direction, the fixed housing includes a pair of fixed-side side walls located outward of the pair of moving-side side walls in the width direction, the pair of fixed-side side walls facing each other in the width direction, end portions of the pair of fixed-side side walls on a mating side being a side that mates to the counterpart connector in the mating direction extend further toward the mating side than end portions of the pair of moving-side side walls on the mating side, each of the plurality of terminals extends in the mating direction, and includes a connecting portion, a contact portion, and an elastic portion, the connecting portions are provided to the terminals on a side opposite to the mating side respectively, and are configured to be connectable to the circuit board, the contact portions are provided to the terminals on the mating side respectively, are configured to be contactable to counterpart terminals provided to the counterpart connector, and are placed in such a manner as to face the receiving portion on opposing surface sides of the pair of moving-side side walls in the width direction, and each of the elastic portions is located between the connecting portion and the contact portion, is provided to either of the pair of restricted portions on a side opposite to the mating side in the mating direction, and is configured to be elastically displaceable in such a manner as to allow relative movement of the moving housing.

### BRIEF DESCRIPTION OF THE DRAWINGS

FIG. 1 is a perspective view of an electrical connector assembly according to an embodiment of the present disclosure, and illustrates a state immediately before a circuit board electrical connector and a counterpart connector are mated and connected together;

FIG. 2A is a cross-sectional perspective view of the circuit board electrical connector of FIG. 1 at a position of signal terminals in a terminal arrangement direction, and FIG. 2B is a partial enlarged view of FIG. 2A;

FIG. 3A is a cross-sectional perspective view of the circuit board electrical connector of FIG. 2B at a position of hole portions in an up-and-down direction, and FIG. 3B is a plan view illustrating a part of FIG. 3A;

FIG. 4 is a cross-sectional view of the electrical connector assembly at a position of signal terminals in the terminal arrangement direction, and illustrates a state immediately before mating and connection;

FIGS. 5A and 5B are cross-sectional views, illustrating the circuit board electrical connector of FIG. 4 together with a test finger, FIG. 5A illustrates a state where the test finger is in contact with moving-side prevention portions, and FIG. 5B illustrates a state where the test finger is in contact with a fixed-side prevention portion and the moving-side prevention portion;

FIG. 6 is a cross-sectional view illustrating a counterpart connector of FIG. 4 together with the test finger, and illustrates a state where the test finger is in contact with counterpart-side prevention portions; and

FIG. 7 is a cross-sectional view of the electrical connector assembly at the position of the signal terminals in the terminal arrangement direction, and illustrates a mated and connected state.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It is known that a test that uses a test finger is conducted on manufactured connectors from the perspective of, for example, electrical shock prevention. Specifically, the test checks to see whether or not the metal test finger comes into contact with terminals and electric current passes through the test finger. The upper parts of the elastic portions of the terminals face the gaps between the lower end of the mating portion and the upper ends of the side walls in the connector of Japanese Patent No. 7109303. Moreover, the mating portion of the moving housing is configured in such a manner as to be movable in the connector width direction due to the elastic displacement of the elastic portions. Therefore, when a tip portion of the test finger is pushed into the above gap, the mating portion is pushed by the above tip portion and moves. As a result, the above gap is widened. Therefore, the tip portion of the test finger may be further pushed in, and come into contact with the upper parts of the elastic portions. In other words, the connector of Japanese Patent No. 7109303 has a difficulty in preventing electrical shock.

In view of such circumstances, one of objects of the present disclosure is to provide a circuit board electrical connector and a connector assembly that can prevent contact of a test finger with a terminal and excellently prevent electrical shock.

(1) A circuit board electrical connector according to the present disclosure is a circuit board electrical connector that is placed on a circuit board and is mated and connected to a counterpart connector, the circuit board electrical connector including: a plurality of terminals; a fixed housing configured to be fixed to the circuit board via the plurality of terminals; and a moving housing configured to be movable relative to the fixed housing, in which the plurality of terminals is arranged in a terminal arrangement direction perpendicular to a mating direction of the circuit board electrical connector and the counterpart connector and a width direction of the circuit board electrical connector, and is provided, extending from the fixed housing to the moving housing, the moving housing includes: a pair of moving-side side walls facing each other in the width direction; a receiving portion capable of receiving a part of the counterpart connector, the receiving portion being formed between the pair of moving-side side walls; and a pair of restricted portions capable of coming into contact with the fixed housing, the pair of restricted portions protruding outward of the pair of moving-side side walls in the width direction, the fixed housing includes a pair of fixed-side side walls located outward of the pair of moving-side side walls in the width direction, the pair of fixed-side side walls facing each other in the width direction, end portions of the pair of fixed-side side walls on a mating side being a side that mates to the counterpart connector in the mating direction extend further toward the mating side than end portions of the pair of moving-side side walls on the mating side, each of the plurality of terminals extends in the mating direction, and includes a connecting portion, a contact portion, and an elastic portion, the connecting portions are provided to the terminals on a side opposite to the mating side respectively, and are configured to be connectable to the circuit board, the contact portions are provided to the terminals on the mating side respectively, are configured to be contactable to counterpart terminals provided to the counterpart connector, and are placed in such a manner as to face the receiving portion on opposing surface sides of the pair of moving-side side walls in the width direction, and each of the elastic portions is located between the connecting portion and the contact portion, is provided to either of the pair of restricted portions on a side opposite to the mating side in the mating direction, and is configured to be elastically displaceable in such a manner as to allow relative movement of the moving housing.

(2) Each of the pair of moving-side side walls includes, on the mating side, a moving-side prevention portion that comes into contact with a test finger to prevent the test finger from entering the receiving portion, and each of the pair of fixed-side side walls includes, on the mating side, a fixed-side prevention portion that comes into contact with the test finger to prevent the test finger from entering between the fixed-side side walls and the moving-side side walls in combination with the pair of moving-side side walls.

In the present disclosure, when the test finger is brought close to gaps between the moving-side side walls and the fixed-side side walls from the mating side upon a test for electrical shock prevention, the fixed-side prevention portions of the fixed-side side walls and the moving-side side walls come into contact with the test finger. Consequently, the entrance of the test finger into the above gaps is prevented. Therefore, the test finger does not come into contact with the elastic portions of the terminals. Moreover, the fixed-side side walls extend further toward the mating side than end portions of the moving-side side walls on the mating side in the connector mating direction. Consequently, the fixed-side prevention portions are provided to portions located on the mating side relative to the end portions of the moving-side side walls on the mating side. Therefore, the fixed-side prevention portions are located further away from the elastic portions of the terminals than if the fixed-side prevention portions are provided at the same position as the above end portions in the connector mating direction, or on a side opposite to the mating side relative to the above end portions. As a result, the fixed-side prevention portions prevent the entrance of the test finger at the position far away from the elastic portions of the terminals. Consequently, it is possible to further ensure that the test finger is prevented from coming into contact with the elastic portions.

Moreover, the elastic portions of the terminals are provided on the side opposite to the mating side relative to the restricted portions of the moving housing in the connector mating direction. In other words, the elastic portions are located far away from the positions of openings of the above gaps on the side opposite to the mating side. Therefore, it is further ensured to prevent the test finger from coming into contact with the elastic portions.

Moreover, in the present disclosure, when the test finger is brought close to between the pair of moving-side side walls, that is, the receiving portion, from the mating side upon the test for electrical shock prevention, the moving-side prevention portions of the pair of moving-side side walls come into contact with the test finger to prevent the test finger from entering the receiving portion. Therefore, the test finger does not come into contact with the contact portions of the terminals. Moreover, in the present disclosure, the contact portions of the terminals are placed in such a manner that opposing surface sides of the pair of moving-side side walls face the receiving portion. A distance between the opposing surfaces of the pair of moving-side side walls is invariant, and the test finger does not force the gap between the opposing surfaces wider. Therefore, the contact portions of the terminals are placed on the opposing surface sides of the moving-side side walls as described above. Consequently, it is further ensured to prevent the test finger from coming into contact with the contact portions of the terminals.

(3) An electrical connector assembly according to the present disclosure includes: the circuit board electrical connector according to the disclosure of (1); and the counterpart connector, in which the counterpart connector includes: the counterpart terminals arranged in the same direction as the terminal arrangement direction; and a counterpart housing that holds the counterpart terminals, the counterpart housing includes: a fit-in wall capable of fitting into the receiving portion, the fit-in wall extending toward a counterpart mating side being a side that mates to the circuit board electrical connector in the mating direction; and a pair of counterpart side walls that extends toward the counterpart mating side, is located outward of the fit-in wall in a width direction of the counterpart connector perpendicular to the mating direction and the terminal arrangement direction, and faces each other, end portions of the pair of counterpart side walls on the counterpart mating side extend further toward the counterpart mating side than an end portion of the fit-in wall on the counterpart mating side, and each of the counterpart terminals extends in the mating direction, includes a counterpart contact portion contactable to the contact portion of its corresponding terminal, and the counterpart contact portions are placed on outer surfaces of the fit-in wall in the width direction of the counterpart connector.

(4) The fit-in wall and the pair of counterpart side walls each include, on the counterpart mating side, a counterpart-side prevention portion that comes into contact with a test finger to prevent the test finger from entering between the fit-in wall and the pair of counterpart side walls.

In the present disclosure, when the test finger is brought close to gaps between the fit-in wall of the counterpart connector and the pair of counterpart side walls from the counterpart mating side upon the test for electrical shock prevention, the fit-in wall and the counterpart-side prevention portions of the pair of counterpart side walls come into contact with the test finger. Consequently, the entrance of the test finger into the above gaps is prevented. Therefore, the test finger does not come into contact with the counterpart terminals. Moreover, the counterpart side walls extend further toward the counterpart mating side than the end portion of the fit-in wall on the counterpart mating side in the connector mating direction. Consequently, the counterpart-side prevention portions are provided to portions located further toward the counterpart mating side than the end portion of the fit-in wall on the counterpart mating side. Therefore, the counterpart-side prevention portions of the counterpart side walls are provided to portions located on the counterpart mating side relative to the end portion of the fit-in wall on the counterpart mating side. Therefore, the counterpart-side prevention portions of the counterpart side walls are located further away from the counterpart terminals than if the counterpart-side prevention portions are provided at the same position as the above end portion of the fit-in wall, or on the side opposite to the mating side relative to the above end portion, in the connector mating direction. As a result, the counterpart-side prevention portions prevent the entrance of the test finger at the position far away from the counterpart terminals. Consequently, it is possible to further ensure that the test finger is prevented from coming into contact with the counterpart terminals.

(5) In the disclosure of (3), in a state where the circuit board electrical connector and the counterpart connector are mated, portions on the counterpart mating side of the counterpart side walls may be configured to be capable of entering between the fixed-side side walls and the moving-side side walls.

In such a configuration, portions on the counterpart mating side of the counterpart side walls are located inward of the fixed-side side walls in the connector width direction in the connector mated state. Therefore, it is possible to avoid an increase in the size of the electrical connector assembly in the connector width direction, the increase resulting from providing the counterpart side walls to the counterpart connector.

In the present disclosure, it is possible to provide a circuit board electrical connector and an electrical connector assembly that can prevent a test finger from coming into contact with a terminal and excellently prevent electrical shock.

An embodiment of the present disclosure is described below on the basis of the drawings.

An electrical connector assembly of the embodiment is configured, including a connector 1 and a counterpart connector 2 that is mated and connected to the connector 1. The connector 1 and the counterpart connector 2 are circuit board electrical connectors that are mounted on different circuit boards (not illustrated) respectively. The connector 1 is configured as a socket connector. The counterpart connector 2 is configured as a plug connector. In the embodiment, the connector 1 and the counterpart connector 2 are used to transmit differential signals.

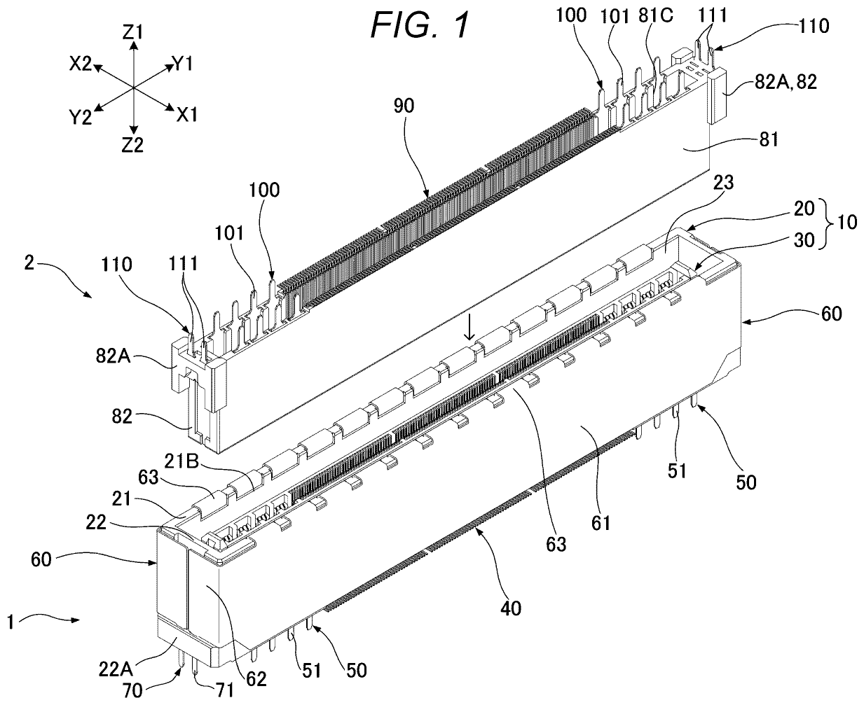

The connector 1 is placed on a mounting surface, which is perpendicular to an up-and-down direction (Z-axis direction), of a circuit board (not illustrated). The counterpart connector 2 is placed on a mounting surface, which is perpendicular to the up-and-down direction (Z-axis direction), of the other circuit board (not illustrated). The connector 1 and the counterpart connector 2 are mated and connected together in orientations where the mounting surfaces of the circuit board and the other circuit board face each other in the up-and-down direction with the up-and-down direction (Z-axis direction) as a connector mating direction as illustrated in FIG. 1. Specifically, it is configured in such a manner that the counterpart connector 2 is mated and connected to the connector 1 from above. In other words, an upper side (Z1 side) of the connector 1 is a side mating to the counterpart connector 2. Moreover, a lower side (Z2 side) of the counterpart connector 2 is a side mating to the connector 1 (a counterpart mating side).

The connector 1 includes a housing 10, a plurality of narrow terminals 40, a plurality of wide terminals 50, two shielding plates 60, and two fastening fittings 70. The housing 10 extends with one direction (Y-axis direction) parallel to the mounting surface of the circuit board as a longitudinal direction. The plurality of narrow terminals 40 and the plurality of wide terminals 50 are arranged and held in the housing 10 with the longitudinal direction as a terminal arrangement direction (the narrow terminals 40 and the wide terminals 50 may be referred to below as the “terminals 40 and 50” if not necessary to be distinguished). The two shielding plates 60 and the two fastening fittings 70 are held by the housing 10.

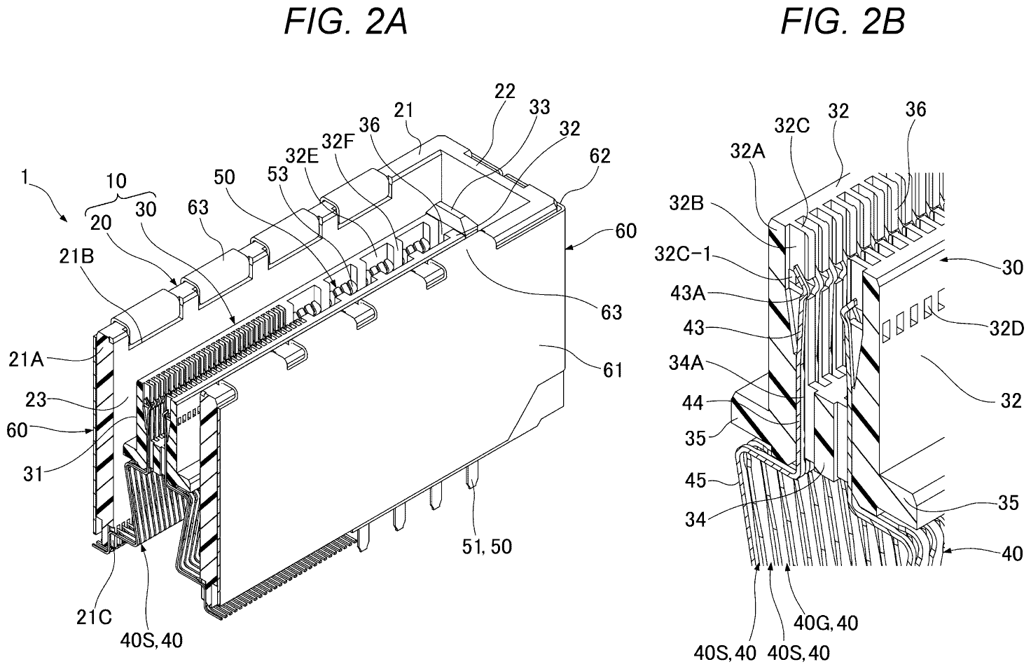

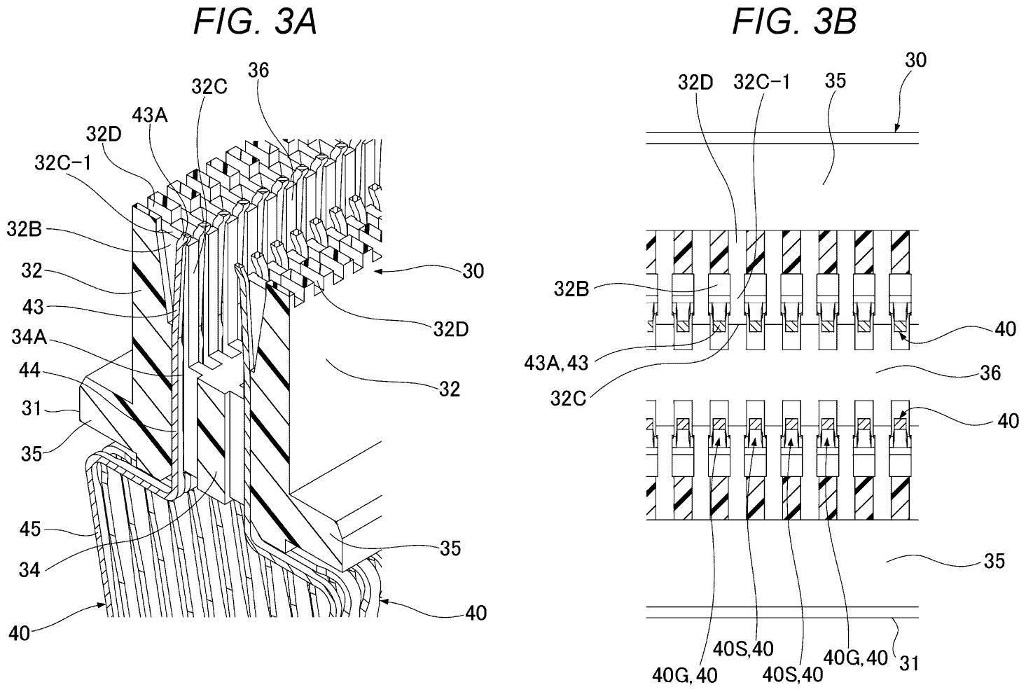

In the embodiment, as illustrated in FIG. 1, the plurality of narrow terminals 40 is arranged in a middle area of the housing 10 in the terminal arrangement direction (Y-axis direction), and the plurality of wide terminals 50 is arranged in areas on both sides of the arrangement area of the narrow terminals 40 in the terminal arrangement direction. As illustrated in FIGS. 2B and 3B, the plurality of narrow terminals 40 includes signal terminals 40S and ground terminals 40G. Moreover, the wide terminals 50 are used as power supply terminals.

The housing 10 is made of an electrical insulating material such as resin, and includes a fixed housing 20 that is attached to the circuit board via the terminals 40 and 50, and a moving housing 30 that is a member different from the fixed housing 20 and is movable relative to the fixed housing 20. In the embodiment, the terminals 40 and 50 are provided, extending from the fixed housing 20 to the moving housing 30, and the elastic displacement of the terminals 40 and 50 allows the moving housing 30 to move (float) relative to the fixed housing 20.

The fixed housing 20 has an approximately rectangular cuboid shape that extends with the terminal arrangement direction (Y-axis direction) as a longitudinal direction, and includes a rectangular frame-shaped peripheral wall having an internal space 23 that penetrates in the up-and-down direction. As illustrated in FIG. 1, the peripheral wall of the fixed housing 20 includes two fixed-side side walls 21 that extend in the terminal arrangement direction (Y-axis direction), and two fixed-side end walls 22 that extend in a connector width direction (X-axis direction) and couple end portions of the fixed-side side walls 21.

Put another way, in the embodiment, a longitudinal direction of the connector 1 is the terminal arrangement direction (Y-axis direction), and a lateral direction of the connector 1 is the connector width direction (X-axis direction). The mating direction is the up-and-down direction (Z-axis direction) orthogonal to the longitudinal and lateral directions.

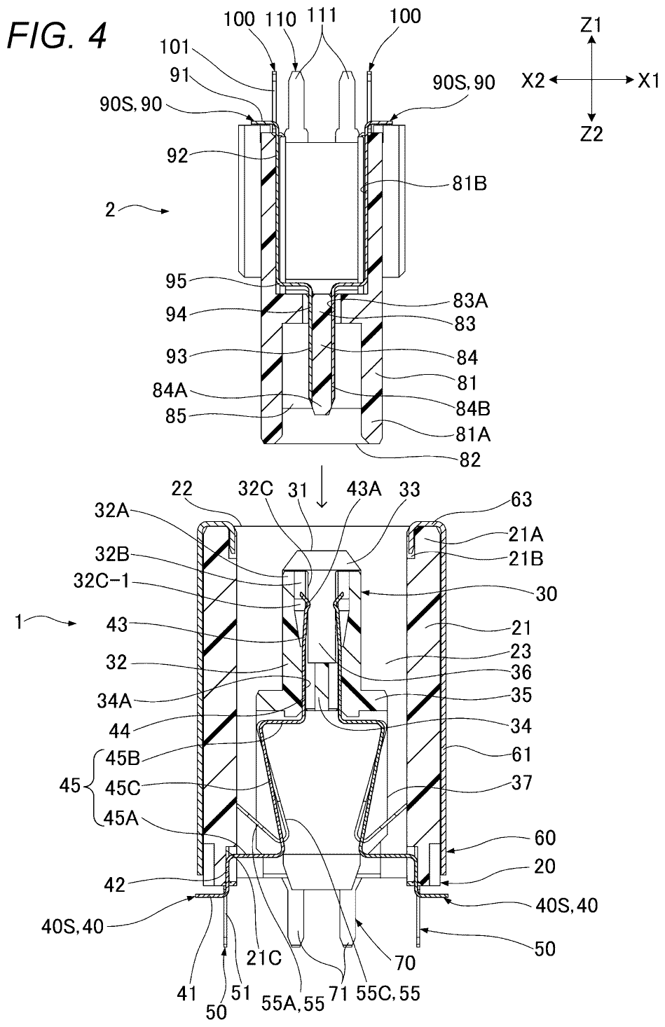

The internal space 23 of the fixed housing 20 accommodates the moving housing 30. As illustrated in FIG. 4, the internal space 23 includes almost the entire moving housing 30 in the up-and-down direction. Moreover, the fixed-side side walls 21 and the fixed-side end walls 22 extend further upward, that is, toward the mating side, than an upper end portion of the moving housing 30.

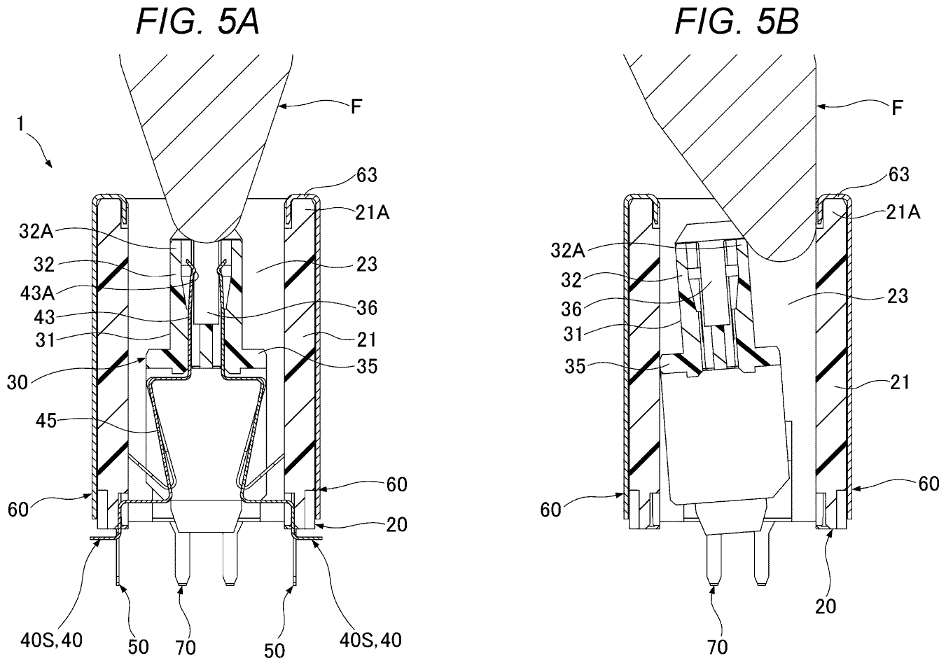

As illustrated in FIGS. 2A and 4, the fixed-side side walls 21 are located outward of the moving housing 30 in the connector width direction. Upper end portions of the fixed-side side walls 21 form fixed-side prevention portions 21A that can come into contact with a test finger F (refer to FIGS. 5A and 5B) described below. The fixed-side prevention portions 21A are configured in such a manner as to come into contact with the test finger F to prevent the test finger F from entering between each of the fixed-side side walls 21 and the moving housing 30 upon a test for electrical shock prevention on the connector 1 (refer to FIG. 5B).

Moreover, the upper end portions of the fixed-side side walls 21 are formed with attachment portions 21B for attaching the shielding plates 60 at a plurality of positions in the terminal arrangement direction as illustrated in FIGS. 1, 2A, and 4. The attachment portions 21B are formed, recessed into inner surfaces of the upper end portions of the fixed-side side walls 21. Lower end portions of the fixed-side side walls 21 are formed with a plurality of fixed-side narrow holding portions 21C (refer to FIGS. 2A and 4) for attaching the narrow terminals 40, and fixed-side wide holding portions (not illustrated) for attaching the wide terminals 50. The fixed-side narrow holding portions 21C and the fixed-side wide holding portions are formed in groove shapes that are recessed into inner surfaces of the lower end portions of the fixed-side side walls 21. The fixed-side wide holding portions are larger in the terminal arrangement direction than the fixed-side narrow holding portions 21C, that is, wide.

As illustrated in FIG. 1, each of the fixed-side end walls 22 includes, in its lower part, a fitting holding portion 22A for holding the fastening fitting 70. Each of the fitting holding portions 22A is formed, protruding outward in the terminal arrangement direction, and is configured in such a manner as to hold the fastening fitting 70 by press-fitting the fastening fitting 70 into a groove-shaped portion (not illustrated) extending in the up-and-down direction. Each of the fitting holding portions 22A faces a part of a lower surface (thickness surface) of the shielding plate 60 from below.

As illustrated in FIG. 4, the moving housing 30 includes a mating portion 31 for mating to the counterpart connector 2 and lock portions 37 that lock with the fixed housing 20 from below. The mating portion 31 includes two moving-side side walls 32 as terminal arrangement walls that extend in the terminal arrangement direction, two moving-side end walls 33 that extend in the connector width direction and couple end portions of the moving-side side walls 32, a bottom wall 34 that blocks a lower end portion of an internal space of the mating portion 31, and restricted portions 35 that protrude from outer surfaces of lower parts of the moving-side side walls 32. Moreover, the internal space that is surrounded by the moving-side side walls 32 and the moving-side end walls 33 and opens upward is formed as a receiving portion 36 for receiving a part of the counterpart connector 2.

Upper end portions of the moving-side side walls 32 form moving-side prevention portions 32A that can come into contact with the test finger F. In the embodiment, a distance between inner surfaces of the moving-side side walls 32, that is, a dimension of the receiving portion 36, in the connector width direction is less than a dimension of a tip portion of the test finger F (refer to FIGS. 5A and 5B). Therefore, the moving-side prevention portions 32A are configured in such a manner as to come into contact with the test finger F to prevent the test finger F from entering the receiving portion 36 upon the test for electrical shock prevention on the connector 1 (refer to FIG. 5A).

As illustrated in FIGS. 2B, 3A, and 3B, the moving-side side walls 32 are formed with a plurality of narrow accommodating groove portions 32B that can accommodate contact arm portions 43 of the narrow terminals 40, the plurality of narrow accommodating groove portions 32B being arranged in the terminal arrangement direction in the arrangement area of the narrow terminals 40. The narrow accommodating groove portions 32B are recessed into the inner surfaces (arrangement surfaces where the contact arm portions 43 are arranged) of the moving-side side walls 32 and extend in the up-and-down direction. Narrow partition portions 32C that separate the narrow accommodating groove portions 32B are formed between adjacent narrow accommodating groove portions 32B, extending in the up-and-down direction. In this manner, the narrow accommodating groove portions 32B and the narrow partition portions 32C are alternately formed in the terminal arrangement direction in the arrangement area of the narrow terminals 40.

As illustrated in FIG. 2B, an upper part of each of the narrow partition portions 32C is formed with a notch portion 32C-1 that penetrates the narrow partition portion 32C in the terminal arrangement direction (Y-axis direction). As illustrated in FIGS. 3A and 3B, each of the notch portions 32C-1 penetrates the narrow partition portion 32C also in the connector width direction (X-axis direction), and causes a hole portion 32D described below to communicate with the receiving portion 36. Each of the notch portions 32C-1 is formed in an area corresponding to a contact portion 43A of the contact arm portion 43, specifically, in an area including a protrusion top portion of the contact portion 43A, in the up-and-down direction as illustrated in FIGS. 2B and 4.

Moreover, each of the moving-side side walls 32 is formed with the notch portions 32C-1 and the hole portions 32D as illustrated in FIGS. 2B, 3A, and 3B. The hole portions 32D are formed at the same positions as the notch portions 32C-1 in the terminal arrangement direction and in the up-and-down direction. The hole portions 32D are formed, penetrating the moving-side side walls 32 in a wall thickness direction of the moving-side side walls 32, that is, the connector width direction, and communicate with the notch portions 32C-1.

Moreover, each of the moving-side side walls 32 is formed with a plurality of wide accommodating groove portions 32E that can accommodate contact arm portions 53 of the wide terminals 50, the plurality of wide accommodating groove portions 32E being arranged in the terminal arrangement direction in the arrangement area of the wide terminals 50. The wide accommodating groove portions 32E are recessed into the inner surfaces (arrangement surface where the contact arm portions 53 are arranged) of the moving-side side walls 32 and extend in the up-and-down direction. The wide accommodating groove portions 32E are formed with a greater groove width than the narrow accommodating groove portions 32B, in other words, is formed to be large in the terminal arrangement direction. Wide partition portions 32F that separate the wide accommodating groove portions 32E extend in the up-and-down direction between adjacent wide accommodating groove portions 32E. In other words, the wide accommodating groove portions 32E and the wide partition portions 32F are alternately formed in the terminal arrangement direction in the arrangement area of the wide terminals 50. The wide partition portions 32F are formed to be thicker than the narrow partition walls 32C, in other words, is formed to be large in the terminal arrangement direction.

The bottom wall 34 is formed with moving-side narrow holding portions 34A for attaching the narrow terminals 40, below the narrow accommodating groove portions 32B, and is formed with moving-side wide holding portions (not illustrated) for attaching the wide terminals 50, below the wide accommodating groove portions 32E. The moving-side narrow holding portions 34A and the moving-side wide holding portions have hole shapes that extend in the up-and-down direction and penetrate the bottom wall 34. The moving-side narrow holding portions 34A communicate with the narrow accommodating groove portions 32B, and the moving-side wide holding portions communicate with the wide accommodating groove portions 32E.

Each of the restricted portions 35 protrudes outward in the connector width direction from the outer surface (the surface perpendicular to the connector width direction) of the lower part of the moving-side side wall 32, and extends from side to side of the moving-side side wall 32 in the terminal arrangement direction. The restricted portions 35 are configured in such a manner as to be capable of coming into contact with the inner surfaces of the fixed-side side walls 21 when the moving housing 30 moves (floats) in the connector width direction (refer to FIG. 5B). In this manner, the restricted portions 35 come into contact with the inner surfaces of the fixed-side side walls 21. Consequently, the movement of the moving housing 30 in the connector width direction is limited to a predetermined amount or less.

The lock portions 37 of the moving housing 30 are provided, extending downward from both end portions of the mating portion 31 in the terminal arrangement direction. Each of the lock portions 37 includes a lock claw portion (not illustrated) protruding outward in the terminal arrangement direction, and the lock claw portions are configured in such a manner as to be capable of locking, from below, with stepped locked portions (not illustrated) formed on inner end surfaces (surfaces perpendicular to the terminal arrangement direction) of the fixed-side end walls 22. The lock claw portions of the lock portions 37 are configured in such a manner as to lock with the locked portions of the fixed-side end walls 22 to limit the upward movement of the moving housing 30 to a predetermined amount or less.

The plurality of narrow terminals 40 includes the signal terminals 40S and the ground terminals 40G as already described (refer to FIGS. 2B and 3B). The plurality of narrow terminals 40 includes a plurality of signal terminal pairs each formed by two adjacent signal terminals 40S, and it is configured in such a manner that these signal terminal pairs can transmit differential signals. Moreover, the ground terminals 40G are adjacent to the signal terminal pairs, one on each side of each pair.

Each of the narrow terminals 40 is created by bending a metal strip in its thickness direction, and is placed in such a manner that its terminal width direction (a direction perpendicular to the thickness direction of the narrow terminal 40) agrees with the terminal arrangement direction (Y-axis direction). As illustrated in FIG. 4, each of the narrow terminals 40 includes a connecting portion 41 formed at one end portion (an opposite side to the mating side) located in its lower part, a fixed-side held portion 42 extending upward from the connecting portion 41, the contact arm portion 43 as an arm portion formed above the connecting portion 41 and at the other end portion (on the mating side) located inward of the one end portion in the connector width direction, a moving-side held portion 44 extending downward from the contact arm portion 43, and an elastic portion 45 coupling the fixed-side held portion 42 and the moving-side held portion 44. The narrow terminals 40 are provided in pairs in such a manner as to be symmetric in the connector width direction (X-axis direction), and these pairs are arranged in the terminal arrangement direction (Y-axis direction).

As illustrated in FIG. 4, each of the connecting portions 41 is configured in such a manner as to extend outward in the connector width direction immediately below the fixed-side side wall 21 and to be soldered and connected to its corresponding circuit portion (for example, a pad) on the mounting surface of the circuit board (not illustrated). Each of the fixed-side held portions 42 is bent at right angles at an inner end (an end portion on the inner side in the connector width direction) of the connecting portion 41, extends upward, and is press-fitted and held in the fixed-side narrow holding portion 21C of the fixed housing 20.

As illustrated in FIG. 4, each of the contact arm portions 43 extends in the up-and-down direction in the narrow accommodating groove portion 32B of the moving housing 30, is placed in such a manner as to face the receiving portion 36, and is configured in such a manner as to be elastically displaceable in the connector width direction. Note that in the embodiment, each of the contact arm portions 43 is accommodated in the narrow accommodating groove portion 32B in a free state; however, instead of this, each of the contact arm portions 43 may be configured in such a manner as to be located outside the narrow accommodating groove portion 32B when in a free state and to be accommodated in the narrow accommodating groove portion 32B when being elastically displaced outward in the connector width direction in a connector mated state.

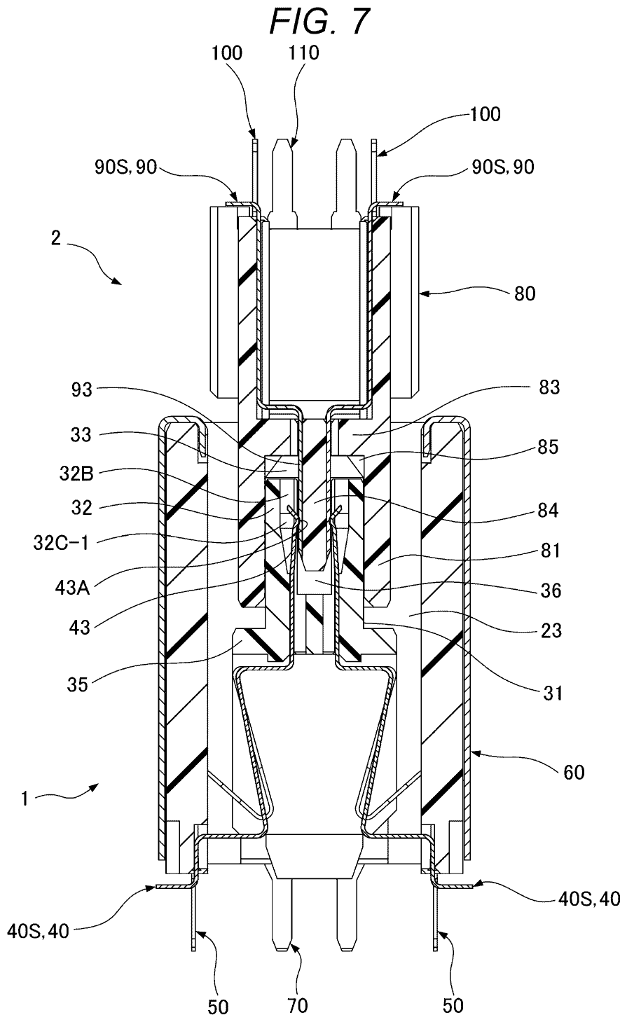

Each of the contact arm portions 43 includes, in its upper end portion, a contact portion 43A for coming into contact with a counterpart narrow terminal 90 being a counterpart terminal. Each of the contact portions 43A is formed, bent in such a manner as to protrude and curve inward in the connector width direction, that is, toward a counterpart signal terminal 90S (refer to FIG. 7) in a state where the connector 1 and the counterpart connector 2 are mated and connected together. As illustrated in FIG. 4, the protrusion top portion of each of the contact portions 43A protrudes from the narrow accommodating groove portion 32B and is located in the receiving portion 36. Moreover, the protrusion top portion of each of the contact portions 43A is located within the area of the notch portion 32C-1 of the moving housing 30 in the up-and-down direction. Each of the moving-side held portions 44 extends downward from a lower end of the contact arm portion 43, and is press-fitted and held in the moving-side narrow holding portion 34A of the moving housing 30.

As illustrated in FIG. 4, each of the elastic portions 45 is provided below the mating portion 31 and couples an upper end of the fixed-side held portion 42 and a lower end of the moving-side held portion 44. Each of the elastic portions 45 includes a lower arm portion 45A, an upper arm portion 45B, and a middle arm portion 45C, and has an approximately Z shape as viewed in the terminal arrangement direction. Each of the lower arm portions 45A is bent at right angles at the upper end of the fixed-side held portion 42 and extends in a straight line and inward in the connector width direction. Each of the upper arm portions 45B is bent at right angles at the lower end of the moving-side held portion 44 and extends in a straight line and outward in the connector width direction along an undersurface of the moving housing 30. Each of the middle arm portions 45C extends in a straight line and upward from an inner end of the lower arm portion 45A, inclined progressively outward in the connector width direction, and couples the inner end of the lower arm portion 45A and an outer end of the upper arm portion 45B. Each of the elastic portions 45 is configured in such a manner as to be elastically displaceable in the connector width direction (X-axis direction), in the terminal arrangement direction (Y-axis direction), and in the up-and-down direction (Z-axis direction).

The wide terminals 50 are used as power supply terminals as already described. Each of the wide terminals 50 is created by bending a metal strip in its thickness direction, and is placed in such a manner that its terminal width direction (a direction perpendicular to the thickness direction of the wide terminal 50) agrees with the terminal arrangement direction (Y-axis direction). The wide terminals 50 are formed to be larger in dimension in the terminal width direction than the narrow terminals 40, that is, to be wide.

Specifically, each of the wide terminals 50 includes a connecting portion 51 (refer to FIG. 4) formed at one end portion located in its lower part, a fixed-side held portion (not illustrated) extending upward from the connecting portion 51, a contact arm portion 53 (refer to FIG. 2A) formed above the connecting portion 51 and at the other end portion located inward of the one end portion in the connector width direction, a moving-side held portion (not illustrated) extending downward from the contact arm portion 53, and an elastic portion 55 (refer to FIG. 4) that couples the fixed-side held portion and the moving-side held portion. Moreover, each of the elastic portions 55 includes a lower arm portion 55A, an upper arm portion (not illustrated), and a middle arm portion 55C.

As illustrated in FIG. 4, the wide terminals 50 have a shape similar to the narrow terminals 40 as viewed in the terminal arrangement direction. However, the shapes of the connecting portions 51 and the elastic portions 55 are different from the shapes of the connecting portions 41 and the elastic portions 45 of the narrow terminals 40.

Each of the connecting portions 51 extends downward in a straight line from a lower end of the fixed-side holding portion, and is inserted through its corresponding hole-shaped circuit portion (for example, a through-hole) of the circuit board (not illustrated) and soldered and connected thereto. As illustrated in FIG. 4, a bent portion at a coupling position between the lower arm portion 55A and the middle arm portion 55C of each of the elastic portions 55 forms an acuter angle than the bent portion of each of the elastic portions 45. As a result, each of the lower arm portions 55A extends outward in the connector width direction, inclined progressively upward.

The elastic portions 55 are configured in such a manner as to be elastically displaceable in the connector width direction (X-axis direction), in the terminal arrangement direction (Y-axis direction), and in the up-and-down direction (Z-axis direction) as in the elastic portions 45. In the embodiment, it is configured in such a manner that the elastic portions 45 of the narrow terminals 40 and the elastic portions 55 of the wide terminals 50 are elastically displaced to allow the moving housing 30 to move (float) relative to the fixed housing 20.

Each of the shielding plates 60 is created by bending a metal plate member in its thickness direction as illustrated in FIGS. 1 and 2A, and includes side plate portions 61 that cover outer surfaces of the fixed-side side walls 21, end plate portions 62 that cover outer end surfaces of the fixed-side end walls 22, and a plurality of attached portions 63 that is attached to the attachment portions 21B of the fixed-side side walls 21.

The side plate portions 61 have a flat plate shape that extends along the outer surfaces of the fixed-side side walls 21, and cover almost the entire outer surfaces of the fixed-side side walls 21. The end plate portions 62 are bent at right angles at both ends of each of the side plate portions 61 in the terminal arrangement direction, and have a flat plate shape that extends inward in the connector width direction. The end plate portions 62 cover almost the entire outer end surface of each of the fixed-side end walls 22 in the connector width direction, specifically, areas above the fitting holding portions 22A.

The attached portions 63 are provided, extending from upper ends of the side plate portions 61 at a plurality of positions in the terminal arrangement direction. As illustrated in FIG. 4, the attached portions 63 are formed by being bent inward in the connector width direction at the upper ends of the side plate portions 61 and then bent downward, and have an approximately inverted L shape as viewed in the terminal arrangement direction. The attached portions 63 fit in the attachment portions 21B of the fixed-side side walls 21 from above. In the embodiment, the attached portions 63 cover upper surfaces and inner surfaces of the attachment portions 21B. Therefore, the attached portions 63 are configured in such a manner as to be capable of coming into contact with the test finger F that is brought close to the attached portions 63 from above upon the test for electrical shock prevention on the connector 1. In other words, the attached portions 63 are configured in such a manner as to be capable of preventing the test finger F from entering between the fixed-side side walls 21 and the moving-side side walls 32, and each have a function as a fixed-side prevention portion.

Each of the fastening fittings 70 is created by blanking a metal plate member while keeping its plate surface flat, and includes a held plate portion (not illustrated) that is press-fitted and held in the fitting holding portion 22A of the fixed-side end wall 22, and two fastening leg portions 71 that extend downward from the held plate portion. The fastening leg portions 71 extend downward in a straight line from undersurfaces of the fitting holding portions 22A, and are fixed to the circuit board (not illustrated) by being inserted through their corresponding hole-shaped portions (for example, through-holes) of the circuit board and soldered and connected thereto.

The connector 1 configured as described above is assembled in the following procedure: Firstly, the moving-side held portions 44 of the narrow terminals 40 and the moving-side held portions of the wide terminals 50 are press-fitted from below into the moving-side narrow holding portions 34A and the moving-side wide holding portions (not illustrated) of the moving housing 30 respectively to cause the moving housing 30 to hold the terminals 40 and 50. As a result, the contact arm portions 43 of the narrow terminals 40 and the contact arm portions 53 of the wide terminals 50 are accommodated in the narrow accommodating groove portions 32B and the wide accommodating groove portions 32E of the moving housing 30 respectively.

Next, the fixed-side held portions 42 of the narrow terminals 40 and the fixed-side held portions (not illustrated) of the wide terminals 50 are press-fitted from below into the fixed-side narrow holding portions 21C and the fixed-side wide holding portions (not illustrated) of the fixed housing 20 respectively to cause the fixed housing 20 to hold the terminals 40 and 50. The held plate portions of the fastening fittings 70 are then press-fitted from above into the fitting holding portions 22A of the fixed housing 20 to cause the fixed housing 20 to hold the fastening fittings 70.

Next, the attached portions 63 of the shielding plates 60 fit in the attachment portions 21B of the fixed housing 20 from above to cause the fixed housing 20 to hold the shielding plates 60. The terminals 40 and 50, the shielding plates 60, and the fastening fittings 70 are attached to the housing 10 in this manner to complete the connector 1. Note that the shielding plates 60 and the fastening fittings 70 may be attached to the fixed housing 20 before the terminals 40 and 50, or may be attached to the fixed housing 20 at the same time as the terminals 40 and 50.

The counterpart connector 2 includes, as illustrated in FIGS. 1 and 4, a counterpart housing 80, the counterpart narrow terminals 90, a plurality of counterpart wide terminals 100, and two fastening fittings 110. The counterpart housing 80 extends with one direction (Y-axis direction) parallel to the mounting surface of the other circuit board (not illustrated) as a longitudinal direction. The counterpart narrow terminals 90 and the plurality of counterpart wide terminals 100 are arranged and held by the counterpart housing 80 with the longitudinal direction as a terminal arrangement direction (the counterpart narrow terminals 90 and the counterpart wide terminals 100 may be referred to below as the “counterpart terminals 90 and 100” if not necessary to be distinguished). The two fastening fittings 110 are held by the counterpart housing 80.

In the embodiment, the counterpart narrow terminals 90 are arranged in a middle area of the counterpart housing 80 in the terminal arrangement direction. The counterpart wide terminals 100 are provided on both sides of the arrangement area of the counterpart narrow terminals 90 in the terminal arrangement direction. The counterpart narrow terminals 90 include the counterpart signal terminals 90S and counterpart ground terminals (not illustrated) (refer to FIGS. 2B and 3B). Moreover, the counterpart wide terminals 100 are used as power supply terminals. The counterpart signal terminals 90S, the counterpart ground terminals, and the counterpart wide terminals 100 of the counterpart connector 2 are arranged, corresponding to the signal terminals 40S, the ground terminals 40G, and the wide terminals 50 of the connector 1 respectively.

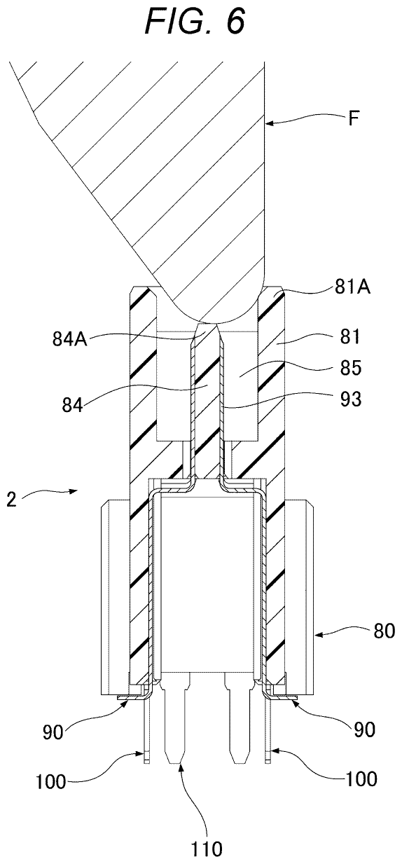

The configuration of the counterpart connector 2 is described below. When the counterpart connector 2 is in an orientation illustrated in FIGS. 1 and 4, a side, which mates to the connector 1, of the counterpart connector 2 is assumed to be “downward,” and a side that is mounted on the other circuit board is assumed to be “upward.” The counterpart housing 80 is made of an electrical insulating material such as resin, and has an approximately rectangular cuboid shape extending with the terminal arrangement direction (Y-axis direction) as a longitudinal direction. The counterpart housing 80 includes a rectangular frame-shaped peripheral wall that is open both upward and downward, a middle wall 83 that divides an internal space of the peripheral wall into two in the up-and-down direction, and a fit-in wall 84 that extends downward from a lower surface of the middle wall 83. A lower end portion of the fit-in wall 84 forms a counterpart-side prevention portion 84A that can come into contact with the test finger F (refer to FIG. 6) described below. It is configured in such a manner that the counterpart-side prevention portion 84A comes into contact with the test finger F to prevent the test finger F from entering between counterpart side walls 81 and the fit-in wall 84 upon the test for electrical shock prevention on the connector 1 (refer to FIG. 6).

As illustrated in FIG. 1, the peripheral wall of the counterpart housing 80 includes two counterpart side walls 81 that extend in the terminal arrangement direction and two counterpart end walls 82 that extend in the connector width direction and couple end portions of the counterpart side walls 81. A space that is located below the middle wall 83 in the internal space of the above peripheral wall and accommodates the fit-in wall 84 forms a counterpart-side receiving portion 85 for receiving a part of the connector 1 from below. In the embodiment, the counterpart-side receiving portion 85 includes the entire fit-in wall 84 in the up-and-down direction as illustrated in FIG. 4. The counterpart side walls 81 and the counterpart end walls 82 extend further downward than the lower end of the fit-in wall 84.

Lower end portions of the counterpart side walls 81 form counterpart-side prevention portions 81A that can come into contact with the test finger F. It is configured in such a manner that upon the test for electrical shock prevention on the connector 1, the counterpart-side prevention portions 81A come into contact with the test finger F to prevent the test finger F from entering between the counterpart side walls 81 and the fit-in wall 84 (refer to FIG. 6).

An inner surface of an upper part (a part located above the middle wall 83) of each of the counterpart side walls 81 is formed with groove-shaped one end-side narrow holding portions 81B (refer to FIG. 4) arranged in the arrangement area of the counterpart narrow terminals 90, and is formed with groove-shaped one end-side wide holding portions 81C (refer to FIG. 1) arranged in the arrangement area of the counterpart wide terminals 100. Each of the one end-side narrow holding portions 81B accommodates and holds a part of the counterpart narrow terminal 90 by press-fitting. Each of the one end-side wide holding portions 81C accommodates and holds a part of the counterpart wide terminal 100 by press-fitting. The one end-side wide holding portions 81C are larger in the terminal arrangement direction than the one end-side narrow holding portions 81B, that is, wide.

As illustrated in FIG. 1, each of the counterpart end walls 82 includes, in its upper part, a fitting holding portion 82A for holding the fastening fitting 110. Each of the fitting holding portions 82A is formed, protruding outward in the terminal arrangement direction, and is configured to hold the fastening fitting 110 by press-fitting the fastening fitting 110 into a groove-shaped portion extending in the up-and-down direction.

The middle wall 83 is formed with the other end-side narrow holding portions 83A (refer to FIG. 4) arranged in the arrangement area of the counterpart narrow terminals 90, and is formed with the other end-side wide holding portions (not illustrated) arranged in the arrangement area of the counterpart wide terminals 100. Each of the other end-side narrow holding portions 83A accommodates and holds a part of the counterpart narrow terminal 90 by press-fitting. Each of the other end-side wide holding portions accommodates and holds a part of the counterpart wide terminal 100 by press-fitting. The other end-side narrow holding portions 83A and the other end-side wide holding portions have hole shapes that extend in the up-and-down direction and penetrate the middle wall 83. The other end-side wide holding portions are larger in the terminal arrangement direction than the other end-side narrow holding portions 83A, that is, wide.

As illustrated in FIG. 4, the fit-in wall 84 extends downward from the lower surface of the middle wall 83 at the central position of the middle wall 83 in the connector width direction, and extends from side to side of the terminal arrangement area in the terminal arrangement direction. Each of side surfaces (surfaces perpendicular to the connector width direction) of the fit-in wall 84 is formed with narrow accommodating groove portions 84B arranged in the arrangement area of the counterpart narrow terminals 90, and is formed with wide accommodating groove portions (not illustrated) arranged in the arrangement area of the counterpart wide terminals 100. The narrow accommodating groove portions 84B communicate with the other end-side narrow holding portions 83A, and the wide accommodating groove portions communicate with the other end-side wide holding portions. Each of the narrow accommodating groove portions 84B accommodates a part of the counterpart narrow terminal 90, and each of the wide accommodating groove portions accommodates a part of the counterpart wide terminal 100.

Each of the counterpart narrow terminals 90 is created by bending a metal strip in its thickness direction, and is placed in such a manner that its terminal width direction (a direction perpendicular to the thickness direction of the counterpart narrow terminal 90) agrees with the terminal arrangement direction (Y-axis direction). As illustrated in FIG. 4, each of the counterpart narrow terminals 90 includes a connecting portion 91 formed at one end portion located in its upper part, a one end-side held portion 92 extending downward from the connecting portion 91, a contact arm portion 93 as a counterpart contact portion formed below the connecting portion 91 and at the other end portion located inward of the one end portion in the connector width direction, the other end-side held portion 94 extending downward from the contact arm portion 93, and a coupling portion 95 coupling the one end-side held portion 92 and the other end-side held portion 94. The counterpart narrow terminals 90 are provided in pairs in such a manner as to be symmetric in the connector width direction (X-axis direction), and these pairs are arranged in the terminal arrangement direction (Y-axis direction).

As illustrated in FIG. 4, each of the connecting portions 91 is configured in such a manner as to extend outward in the connector width direction immediately above the counterpart side wall 81 and to be soldered and connected to its corresponding circuit portion (for example, a pad) on the mounting surface of the other circuit board (not illustrated). Each of the one end-side held portions 92 is bent at right angles at an inner end of the connecting portion 91, extends downward, and is press-fitted and held in the one end-side narrow holding portion 81B of the counterpart housing 80.

As illustrated in FIG. 4, each of the contact arm portions 93 extends in the up-and-down direction in the narrow accommodating groove portion 84B of the counterpart housing 80. Each of the contact arm portions 93 is configured to be capable of coming into contact with the contact portion 43A of the narrow terminal 40 of the connector 1 with a plate surface exposed from the narrow accommodating groove portion 84B as a contact surface. Each of the other end-side held portions 94 extends upward from an upper end of the contact arm portion 93, and is press-fitted and held in the other end-side narrow holding portion 83A of the counterpart housing 80.

As illustrated in FIG. 4, each of the coupling portions 95 is provided above the middle wall 83 and couples a lower end of the one end-side held portion 92 and an upper end of the other end-side held portion 94. Each of the coupling portions 95 extends along an upper surface of the middle wall 83 and an inner surface of the upper part of the counterpart side wall 81, and has an approximately L shape as viewed in the terminal arrangement direction. A part, which extends in the up-and-down direction along the inner surface of the counterpart side wall 81, of each of the coupling portions 95 is accommodated in the one end-side narrow holding portion 81B.

Each of the counterpart wide terminals 100 is created by bending a metal strip in its thickness direction, and is placed in such a manner that its terminal width direction (a direction perpendicular to the thickness direction of the counterpart wide terminal 100) agrees with the terminal arrangement direction (Y-axis direction). The counterpart wide terminals 100 are formed to be larger in the terminal width direction than the counterpart narrow terminals 90, that is, to be wide.

Specifically, each of the counterpart wide terminals 100 has the same shape as the counterpart narrow terminals 90 as viewed in the terminal arrangement direction, except a connecting portion 101 formed at one end portion located in its upper part, as illustrated in FIG. 4. Each of the counterpart wide terminals 100 includes a one end-side held portion, a contact arm portion, the other end-side holding portion, and a coupling portion (none of them is illustrated) in addition to the connecting portion 101. Each of the connecting portions 101 extends upward in a straight line from an upper end of the one end-side held portion, and is inserted through its corresponding hole-shaped circuit portion (for example, a through-hole) of the other circuit board (not illustrated) and soldered and connected thereto.

Each of the fastening fittings 110 is created by blanking a metal plate member while keeping its plate surface flat, and includes a held plate portion (not illustrated) that is press-fitted and held in the fitting holding portion 82A of the counterpart end wall 82, and two fastening leg portions 111 that extend upward from the held plate portion. As illustrated in FIG. 1, each of the fastening leg portions 111 extends upward in a straight line from an upper surface of the fitting holding portion 82A, and is fixed to the other circuit board (not illustrated) by being inserted through its corresponding hole-shaped portion (for example, a through-hole) of the other circuit board and soldered and connected thereto.

The counterpart connector 2 configured as described above is assembled in the following procedure: Firstly, the one end-side held portions 92 of the counterpart narrow terminals 90 and the one end-side held portions (not illustrated) of the counterpart wide terminals 100 are press-fitted from above in FIG. 4 into the one end-side narrow holding portion 81B and the one end-side wide holding portions 81C of the counterpart housing 80. At the same time, the other end-side held portions 94 of the counterpart narrow terminals 90 and the other end-side held portions (not illustrated) of the counterpart wide terminals 100 are press-fitted from above in FIG. 4 into the other end-side narrow holding portions 83A and the other end-side holding portions (not illustrated) of the counterpart housing 80. As a result, the counterpart terminals 90 and 100 are held by the counterpart housing 80.

Moreover, the held plate portions (not illustrated) of the fastening fittings 110 are press-fitted from below into the fitting holding portions 82A of the counterpart housing 80 to cause the counterpart housing 80 to hold the fastening fittings 110. The counterpart terminals 90 and 100 and the fastening fittings 110 are attached to the counterpart housing 80 in this manner to complete the counterpart connector 2. Note that the fastening fittings 110 may be attached to the counterpart housing 80 before the counterpart terminals 90 and 100, or may be attached to the counterpart housing 80 at the same time as the counterpart terminals 90 and 100.

After the connector 1 is assembled, the test that uses the test finger F is conducted on each of the connector 1 and the counterpart connector 2 from the perspective of, for example, electrical shock prevention. Specifically, the metal test finger F is pressed against the mating-side portions of the connector 1 and the counterpart connector 2 to verify whether a state where the test finger F does not come into contact with the terminals 40 and 50 and the counterpart terminals 90 and 100 is secured.

Upon the test on the connector 1, the verification work is conducted of whether the test finger F does not come into contact with the contact arm portions 43 of the narrow terminals 40 and the contact arm portions 53 of the wide terminals 50, which are placed on inner surface sides of the receiving portion 36 of the moving housing 30. As already described, the receiving portion 36 of the moving housing 30 is formed with a smaller dimension in the connector width direction than the tip portion of the test finger F. Therefore, when the test finger F comes close to the moving housing 30 from the mating side, that is, from above, the moving-side prevention portions 32A of the pair of moving-side side walls 32 come into contact with the test finger as illustrated in FIG. 5A. Consequently, the test finger F is prevented from entering the receiving portion 36. Therefore, the test finger F does not come into contact with the contact arm portions 43 and 53. In other words, it is possible to excellently prevent the contact arm portions 43 and 53 from giving an electrical shock.

Moreover, in the embodiment, a distance between opposing surfaces of the pair of moving-side side walls 32 forming the receiving portion 36, that is, a distance (a distance in the connector width direction) between the inner surfaces of the moving-side side walls 32 is invariant, and the test finger F does not force a gap between the opposing surfaces wider. In the embodiment, the contact arm portions 43 of the narrow terminals 40 and the contact arm portions 53 of the wide terminals 50 are placed on the opposing surface sides of the moving-side side walls 32. Consequently, it is further ensured to prevent the test finger F from coming into contact with the contact arm portions 43 and 53.

Moreover, upon the test on the connector 1, verification work is also conducted of whether the test finger F does not come into contact with the elastic portions 45 of the narrow terminals 40 and the elastic portions 55 of the wide terminals 50, which are placed between the fixed housing 20 and the moving housing 30. In the embodiment, a distance (a distance in the connector width direction) between each of the fixed-side side walls 21 and each of the moving-side side walls 32 is less than the tip portion of the test finger F even if the moving housing 30 is located furthest away from the fixed-side side walls 21. Therefore, the test finger F comes into contact with the fixed-side prevention portion 21A and the moving-side prevention portion 32A as illustrated in FIG. 5B when the test finger F is brough close to a gap between the fixed-side side wall 21 and the moving-side side wall 32 from the mating side. As a result, the fixed-side prevention portion 21A and the moving-side prevention portion 32A in combination prevent the test finger F from entering the gap between the fixed-side side wall 21 and the moving-side side wall 32. Therefore, the test finger F does not come into contact with the elastic portions 45 and 55 (their illustrations are omitted in FIG. 5B). In other words, it is possible to excellently prevent the elastic portions 45 and 55 from giving an electrical shock.

FIG. 5B illustrates a state where the test finger F is in contact with an inner surface of the fixed-side prevention portion 21A. However, in the embodiment, the attached portions 63 of the shielding plates 60 are attached to the upper end portions of the fixed-side side walls 21. Consequently, the test finger F may come into contact with the attached portions 63 depending on the position and angle of the test finger F. In this case, the attached portions 63 function as the fixed-side prevention portions, and, in combination with the moving-side prevention portions 32A, prevent the test finger F from entering the gaps between the fixed-side side walls 21 and the moving-side side walls 32.

Moreover, in the embodiment, the fixed-side side walls 21 extend further upward than upper end portions of the moving-side side walls 32. Consequently, the fixed-side prevention portions 21A are provided above the upper end portions of the moving-side side walls 32. Therefore, the fixed-side prevention portions 21A are located further away from the elastic portions 45 and 55 of the terminals 40 and 50 than if the fixed-side prevention portions 21A are provided at the same position as, or below the upper end portions of the moving-side side walls 32. As a result, the fixed-side prevention portions 21A prevent the entrance of the test finger F at the position far away from the elastic portions 45 and 55. Consequently, it is possible to further ensure that the test finger F is prevented from coming into contact with the elastic portions 45 and 55.

Moreover, the elastic portions 45 and 55 of the terminals 40 and 50 are provided below the restricted portions 35 of the moving housing 30. In other words, the elastic portions 45 and 55 are located downward of and far away from positions of upper end openings of the gaps between the fixed-side side walls 21 and the moving-side side walls 32. Therefore, it is further ensured that the test finger F is prevented from coming into contact with the elastic portions 45 and 55.

Upon the test on the counterpart connector 2, verification work is conducted of whether the test finger F does not come into contact with the contact arm portions 93 of the counterpart narrow terminals 90 and the contact arm portions (not illustrated) of the counterpart wide terminals 100, which are placed on outer surfaces of the fit-in wall 84, in the counterpart-side receiving portion 85 of the counterpart housing 80. FIG. 6 illustrates a state where the test finger F is in contact with the counterpart connector 2 upon the test on the counterpart connector 2. FIG. 6 illustrates the counterpart connector 2 in an orientation that is the orientation in FIGS. 1 and 4 vertically inverted, and upward in FIG. 6 is the counterpart mating side.

In the embodiment, a distance (a distance in the connector width direction) between each of the counterpart side walls 81 and the fit-in wall 84 is less than the tip portion of the test finger F. Therefore, when the test finger F is brought close from the mating side (from above in FIG. 6) to the gap between the counterpart side wall 81 and the fit-in wall 84, the counterpart-side prevention portion 81A of the counterpart side wall 81 and the counterpart-side prevention portion 84A of the fit-in wall 84 come into contact with the test finger F as illustrated in FIG. 6. As a result, the counterpart-side prevention portion 81A and the counterpart-side prevention portion 84A in combination prevent the test finger F from entering the gap between the counterpart side wall 81 and the fit-in wall 84. Therefore, the test finger F does not come into contact with the contact arm portions 93 of the counterpart narrow terminals 90 and the contact arm portions (not illustrated) of the counterpart wide terminals 100. In other words, it is possible to excellently prevent the contact arm portions 93 of the counterpart narrow terminals 90 and the contact arm portions of the counterpart wide terminals 100 from giving an electrical shock.

Moreover, as illustrated in FIG. 6, the counterpart side walls 81 extend further upward than an upper end portion of the fit-in wall 84, and the counterpart-side prevention portions 81A are provided above the upper end portion of the fit-in wall 84. Therefore, the counterpart-side prevention portions 81A are located further away from the counterpart terminals 90 and 100 than if the counterpart-side prevention portions are provided at the same position as, or below, the upper end portion of the fit-in wall. As a result, the counterpart-side prevention portions 81A and the counterpart-side prevention portion 84A prevent the entrance of the test finger F at the position far away from the counterpart terminals 90 and 100. Consequently, it is possible to further ensure that the test finger F is prevented from coming into contact with the contact arm portions of the counterpart terminals 90 and 100.

In the embodiment, it is configured in such a manner that the counterpart-side prevention portions 81A of the counterpart side walls 81 and the counterpart-side prevention portion 84A of the fit-in wall 84 come into contact with the test finger F to prevent the entrance of the test finger F. However, the form of the contact is not limited to the above. In the embodiment, a distance between opposing surfaces, that is, a distance between inner surfaces (a distance in the connector width direction) of the pair of counterpart side walls 81 is less than the tip portion of the test finger F as illustrated in FIG. 6. Therefore, as a modification, the pair of counterpart side walls 81 is formed, extending further upward than the one illustrated in FIG. 6, which also makes it possible to bring the counterpart-side prevention portions 81A formed at upper end portions of the pair of counterpart side walls 81 into contact with the test finger F. In this modification, the test finger F does not come into contact with the fit-in wall 84. Consequently, it is possible to excellently prevent the test finger F from coming into contact with the counterpart terminals 90 and 100 placed on the outer surfaces of the fit-in wall 84.

Next, a mating connection operation of the connector 1 and the counterpart connector 2 is described. Firstly, the connector 1 is soldered and connected to the mounting surface of the circuit board (not illustrated) to be mounted thereon, and the counterpart connector 2 is soldered and connected to the mounting surface of the other circuit board (not illustrated) to be mounted thereon. Next, as illustrated in FIGS. 1 and 4, the connector 1 is placed in an orientation where the mating portion 31 faces upward, and the counterpart connecter 2 is placed above the connector 1 in an orientation where the counterpart-side receiving portion 85 is open downward. The counterpart connector 2 is then moved downward to start mating and connecting to the connector 1.

In the connector mating process, the mating portion 31 of the connector 1 enters the counterpart-side receiving portion 85 of the counterpart connector 2 from below. Moreover, at the same time, a peripheral wall of the counterpart connector 2 enters the internal space 23 of the connector 1 from above, and the fit-in wall 84 of the counterpart connector 2 enters the receiving portion 36 of the connector 1 from above. As a result, the contact arm portions 93 of the counterpart narrow terminals 90 come into contact with the contact portions 43A of the narrow terminals 40 to elastically displace the contact arm portions 43 outward in the connector width direction. Moreover, the contact arm portions of the counterpart wide terminals 100 come into contact with the contact portions of the wide terminals 50 to elastically displace the contact arm portion 53 outward in the connector width direction.

Furthermore, the connector mating process moves on. As illustrated in FIG. 7, the mating portion 31 of the connector 1 reaches an undersurface of the counterpart-side receiving portion 85, that is, the lower surface of the middle wall 83, of the counterpart connector 2 to bring the connector 1 and the counterpart connector 2 into a mated and connected state, so that the connector mating connection operation is completed. In the connector mated and connected state, the elastically displaced state of the contact arm portions 43 of the narrow terminals 40 and the contact arm portions 53 of the wide terminals 50 is maintained, and the contact portions 43A and the contact arm portions 93 come into contact with each other under contact pressure, and the contact portions of the wide terminals 50 and the contact arm portions of the counterpart wide terminals 100 come into contact with each other under contact pressure. As a result, the terminals 40 and 50 and the counterpart terminals 90 and 100 are electrically continuous. Note that in FIG. 7, the contact arm portions 43 are not illustrated in the elastically displaced state, but actually the contact arm portions 43 are displaced outward in the connector width direction, and the contact portions 43A are accommodated in the narrow accommodating groove portions 32B. Also in terms of the contact arm portions 53 (refer to FIG. 2A), the contact portions of the contact arm portions 53 are similarly accommodated in the wide accommodating groove portions 32E.

Immediately before the mating of the connector 1 and the counterpart connector 2, or in the mated and connected state, the mating position of the connector 1 and the counterpart connector 2 is not necessarily the right position in the terminal arrangement direction and in the connector width direction, and may be misaligned in these directions. In the embodiment, the moving housing 30 moves (what is called to be floating) in a direction of the misalignment accompanied by the elastic displacement of the elastic portions 45 and 55 of the terminals 40 and 50 to absorb the misalignments between the connector 1 and the counterpart connector 2.

In the embodiment, in the connector mated state, portions (lower parts in FIG. 7) of the counterpart side walls 81 on the counterpart mating side enter between the fixed-side side walls 21 and the moving-side side walls 32 of the connector 1 as illustrated in FIG. 7. In other words, the lower parts of the counterpart side walls 81 are located inward of the fixed-side side walls 21 in the connector width direction. Therefore, it is possible to avoid an increase in the size of the connector assembly in the connector width direction, the increase resulting from providing the counterpart sidewalls 81 to the counterpart connector 2.

In the embodiment, in the mated and connected state, the contact portions 43A of the contact arm portions 43 are accommodated in the narrow accommodating groove portions 32B of the moving housing 30 as already described. The narrow partition portions 32C that separate the adjacent narrow accommodating groove portions 32B are formed with the notch portions 32C-1 in the areas corresponding to the contact portions 43A in the up-and-down direction. In other words, an airspace formed by each of the notch portions 32C-1 is present in the area, which corresponds to the contact portion 43A, of the narrow partition portion 32C. Therefore, in the embodiment, the presence of the airspaces reduces a permittivity in the areas, which correspond to the contact portions 43A, of the narrow partition portions 32C as compared to a case where the narrow partition portions 32C are not formed with the notch portions 32C-1. As a result, impedance in the areas increases. Therefore, an excessive reduction in impedance at contact positions of the contact portions 43A of the signal terminals 40S with the counterpart signal terminals 90S is suppressed, so that signal transmission characteristics are improved.

Moreover, in the embodiment, each of the notch portions 32C-1 is formed, penetrating the narrow partition portion 32C in the terminal arrangement direction. Hence, the airspaces formed in the notch portions 32C-1 of the narrow partition portions 32C can be increased to the maximum. Therefore, the permittivity in the areas corresponding to the contact portions 43A can be reduced to the minimum. As a result, the impedance in these areas increases to the maximum, and an excessive reduction in impedance at the contact positions of the contact portions 43A of the signal terminals 40S with the counterpart signal terminals 90S is further suppressed accordingly, so that the signal transmission characteristics can be further improved.

The contact portions 43A are formed, protruding inward in the connector width direction, and the protrusion top portion of each of the contact portions 43A is configured in such a manner as to come into contact with its respective counterpart narrow terminal 90. In the embodiment, the notch portions 32C-1 of the narrow partition portions 32C are formed at the position aligned with the position of the contact portions 43A in the up-and-down direction. Hence, it is possible to excellently suppress an excessive reduction in impedance at the contact positions of the signal terminals 40S with the counterpart signal terminals 90S without regard to the level of the mating depth of the connector 1 and the counterpart connector 2.

Moreover, in the embodiment, the signal terminal pairs formed by the adjacent signal terminals 40S transmit differential signals as already described. Therefore, the airspace formed by the notch portion 32C-1 is present between adjacent contact portions 43A of each signal terminal pair. As a result, in terms of the signal terminals 40S of each signal terminal pair, it is possible to excellently suppress an excessive reduction in differential impedance at the contact positions of the contact portions 43A with the counterpart signal terminals 90S.

It is configured in the embodiment in such a manner that the adjacent signal terminals 40S form the signal terminal pairs and differential signals are transmitted by the signal terminal pairs. However, the present disclosure is not limited to the above. As a modification, each of the signal terminals 40S may be configured in such a manner as to transmit a signal. In the modification, the ground terminals may not be provided and, for example, all the narrow terminals 40 may be the signal terminals 40S.

In the embodiment, the notch portions 32C-1 are formed, penetrating the narrow partition portions 32C in the connector width direction. However, the present disclosure is not limited to the above. Each of the notch portions 32C-1 may have, for example, a recessed shape recessed into a side surface (a surface perpendicular to the connector width direction) of the narrow partition portion 32C.

In the embodiment, surfaces of the fixed-side prevention portions 21A are exposed to the outside, and the fixed-side prevention portions 21A are configured in such a manner as to be capable of coming into direct contact with the test finger F. However, the present disclosure is not limited to the above. The fixed-side prevention portions 21A may be configured in such a manner as to come into indirect contact with the test finger F. For example, it may be configured in such a manner that each of the attachment portions 21B of the shielding plates 60 is formed, extending from side to side of the fixed-side side wall 21 in the terminal arrangement direction, and fits to an upper part of the fixed-side side wall 21, and the fixed-side prevention portion 21A formed on the upper part of the fixed-side side wall 21 may come into indirect contact with the test finger F via the attachment portion 21B.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A circuit board electrical connector that is placed on a circuit board and is mated and connected to a counterpart connector, the circuit board electrical connector comprising:
a plurality of terminals;
a fixed housing configured to be fixed to the circuit board via the plurality of terminals; and
a moving housing configured to be movable relative to the fixed housing, wherein
the plurality of terminals is arranged in a terminal arrangement direction perpendicular to a mating direction of the circuit board electrical connector and the counterpart connector and a width direction of the circuit board electrical connector, and is provided, extending from the fixed housing to the moving housing,
the moving housing includes: a pair of moving-side side walls facing each other in the width direction; a receiving portion capable of receiving a part of the counterpart connector, the receiving portion being formed between the pair of moving-side side walls; and a pair of restricted portions capable of coming into contact with the fixed housing, the pair of restricted portions protruding outward of the pair of moving-side side walls in the width direction,
the fixed housing includes a pair of fixed-side side walls located outward of the pair of moving-side side walls in the width direction, the pair of fixed-side side walls facing each other in the width direction,
end portions of the pair of fixed-side side walls on a mating side being a side that mates to the counterpart connector in the mating direction extend further toward the mating side than end portions of the pair of moving-side side walls on the mating side,
each of the plurality of terminals extends in the mating direction, and includes a connecting portion, a contact portion, and an elastic portion,
the connecting portions are provided to the terminals on a side opposite to the mating side respectively, and are configured to be connectable to the circuit board,
the contact portions are provided to the terminals on the mating side respectively, are configured to be contactable to counterpart terminals provided to the counterpart connector, and are placed in such a manner as to face the receiving portion on opposing surface sides of the pair of moving-side side walls in the width direction, and
each of the elastic portions is located between the connecting portion and the contact portion, is provided to either of the pair of restricted portions on a side opposite to the mating side in the mating direction, and is configured to be elastically displaceable in such a manner as to allow relative movement of the moving housing.

2. The circuit board electrical connector according to claim 1, wherein
each of the pair of moving-side side walls includes, on the mating side, a moving-side prevention portion that comes into contact with a test finger to prevent the test finger from entering the receiving portion, and
each of the pair of fixed-side side walls includes, on the mating side, a fixed-side prevention portion that comes into contact with the test finger to prevent the test finger from entering between the fixed-side side walls and the moving-side side walls in combination with the pair of moving-side side walls.

3. An electrical connector assembly comprising:
the circuit board electrical connector according to claim 1; and
the counterpart connector, wherein
the counterpart connector includes: the counterpart terminals arranged in the same direction as the terminal arrangement direction; and a counterpart housing that holds the counterpart terminals,
the counterpart housing includes: a fit-in wall capable of fitting into the receiving portion, the fit-in wall extending toward a counterpart mating side being a side that mates to the circuit board electrical connector in the mating direction; and a pair of counterpart side walls that extends toward the counterpart mating side, is located outward of the fit-in wall in a width direction of the counterpart connector perpendicular to the mating direction and the terminal arrangement direction, and faces each other,
end portions of the pair of counterpart side walls on the counterpart mating side extend further toward the counterpart mating side than an end portion of the fit-in wall on the counterpart mating side, and
each of the counterpart terminals extends in the mating direction, includes a counterpart contact portion contactable to the contact portion of its corresponding terminal, and the counterpart contact portions are placed on outer surfaces of the fit-in wall in the width direction of the counterpart connector.

4. The electrical connector assembly according to claim 3, wherein the fit-in wall and the pair of counterpart side walls each include, on the counterpart mating side, a counterpart-side prevention portion that comes into contact with a test finger to prevent the test finger from entering between the fit-in wall and the pair of counterpart side walls.

5. The electrical connector assembly according to claim 3, wherein in a state where the circuit board electrical connector and the counterpart connector are mated, portions on the counterpart mating side of the counterpart side walls are configured to be capable of entering between the fixed-side side walls and the moving-side side walls.
